(19) United States
(12) Patent Application Publication
(10) Pub. No.: US 2016/0005062 A1
(43) Pub. Date: Jan. 7, 2016

(54) PRODUCT-DISTRIBUTION STATION OBSERVATION, REPORTING AND PROCESSING

(71) Applicant: QL2 EUROPE LTD., Marlow (GB)

(72) Inventors: NIKHIL SONPAL, Calgary Alberta (CA); CHARLES HALE, NEW YORK, NY (US); ANDREW NASTIUK, Calgary Alberta (CA); BRUCE HILL, BELMONT, MA (US)

(21) Appl. No.: 14/765,311

(22) PCT Filed: Jan. 31, 2013
(86) PCT No.: PCT/US2013/024015

§ 371 Date: Jul. 31, 2015

Related U.S. Application Data
(60) Provisional application No. 61/592,768, filed on Jan. 31, 2012.

(51) Int. Cl. G06Q 30/02; G06Q 50/06

(52) U.S. Cl. CPC G06Q 30/0205; G06Q 50/06

(57) ABSTRACT

A computer-readable medium on which are stored computer-executable executable instructions that, when executed in at least one electronic system coupled to a display device and a network, enable the at least one system to perform a method comprising at least the steps of determining the geo-location of the system, determining at least one on-sale retail product associated with the determined geo-location of the system, recording a data set indicating a current price of the determined on-sale retail product, and electronically transferring the data set and an indication of the determined geo-location over the network to a processing device.

### PRIORITY CLAIM

This application claims the benefit of, and incorporates by reference in its entirety as if fully set forth herein, U.S. Provisional Pat. Appl. No. 61/592,768 entitled “Product-Distribution Station Observation, Reporting and Processing” and filed Jan. 31, 2012.

### BACKGROUND OF THE INVENTION

Companies in the dynamic petrol/gasoline market handle thousands of price changes daily. Most of the players in the market rely on manual price observations submitted by station operators as the basic inputs that drive their internal pricing processes and systems. These manual observations create significant risks to the brand owner—they are often inaccurate or out of date by the time they are submitted, they cannot be verified, and they take the station operators away from the station.

### BRIEF DESCRIPTION OF THE DRAWINGS

FIG. 1 is a functional block diagram of an exemplary operating environment in which an embodiment of the invention can be implemented;

FIG. 2 depicts elements of the operating environment of FIG. 1;

FIG. 3 depicts a process according to an embodiment; and

FIGS. 4-7 depict user interfaces according to at least one embodiment.

### DETAILED DESCRIPTION

Embodiments of the invention are operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does nor, other than the establishment of user preferences, require manual effort. Also, as used herein the term “observe” may mean record price data, and “observation” may refer to such price data,

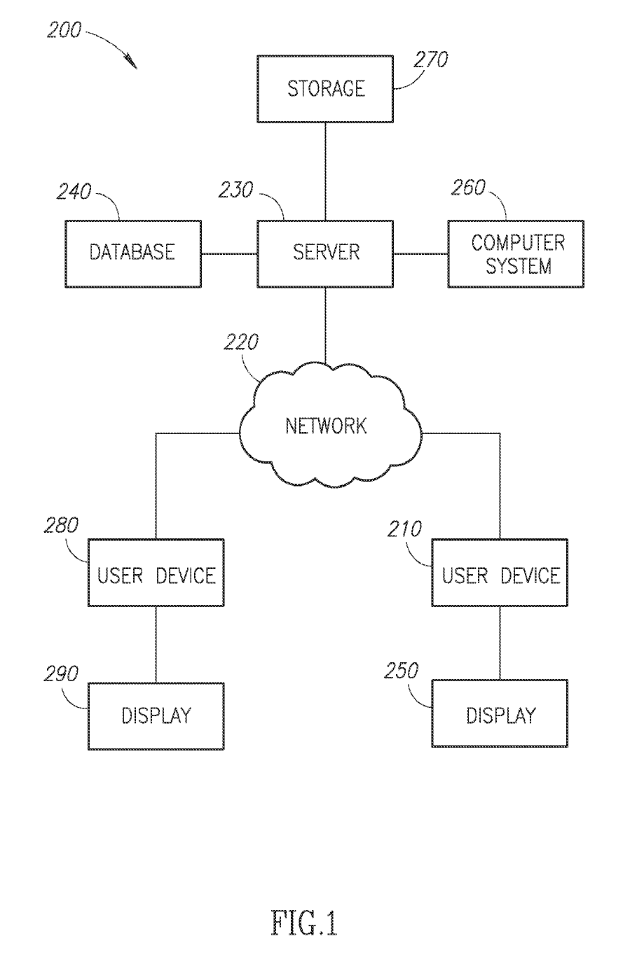

Referring now to FIG. 1, an embodiment of the present invention can be described in the context of an exemplary network system 200 as illustrated. System 200 includes electronic user devices 210, 280, such as personal computers or mobile devices, such as smartphones or tablets, that are linked via a communication medium, such as a network 220 (e.g., the Internet or mobile communication network), to an electronic device or system, such as a server 230. The server 230 may further be coupled, or otherwise have access, to a database 240, electronic storage 270 and a computer system 260. Although the embodiment illustrated in FIG. 1 includes one server 230 coupled to two user devices 210, 280 via the network 220, it should be recognized that embodiments of the invention may be implemented using two or more such user devices coupled to one or more such servers.

User devices 210, 280 include or are otherwise coupled to a computer screen or display 250, 290, respectively. User devices 210, 280 can be used for various purposes including both network- and local-computing processes.

The user devices 210, 280 are linked via the network 220 to server 230 so that computer programs, such as, for example, a browser or other applications, running on the user devices 210, 280 can cooperate in two-way communication with server 230. Server 230 may be coupled to database 240 and/or electronic storage 270 to retrieve information therefrom and to store information thereto. Additionally, the server 230 may be coupled to the computer system 260 in a manner allowing the server to delegate certain processing functions to the computer system.

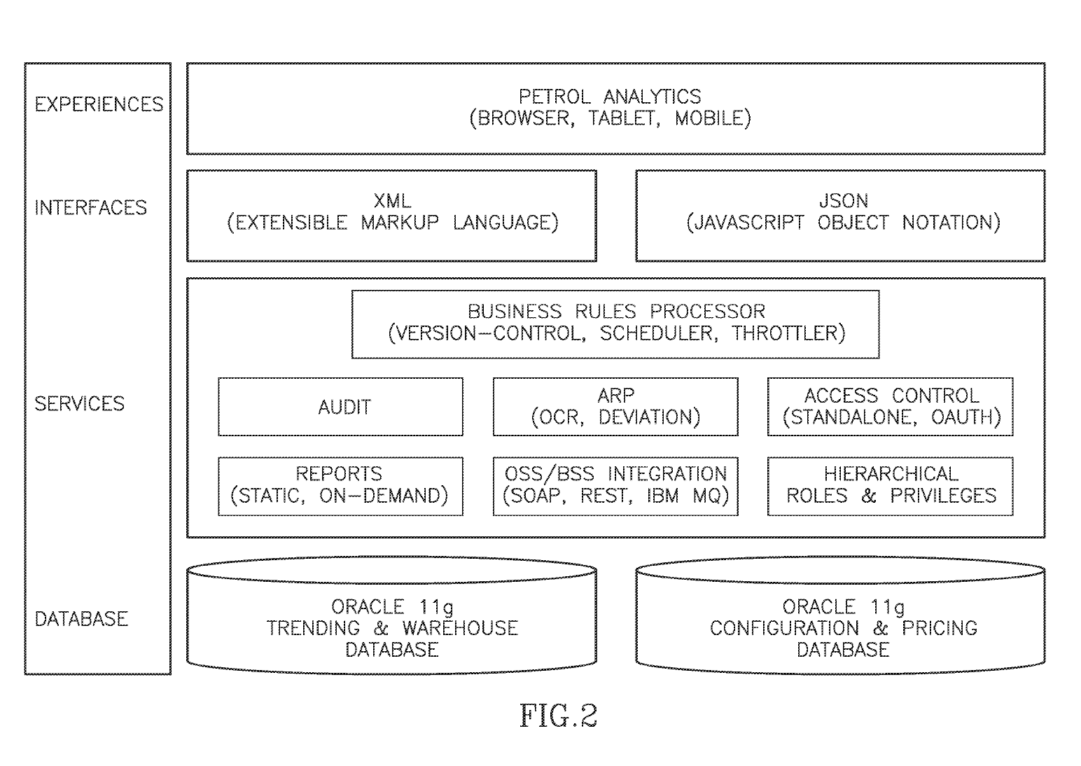

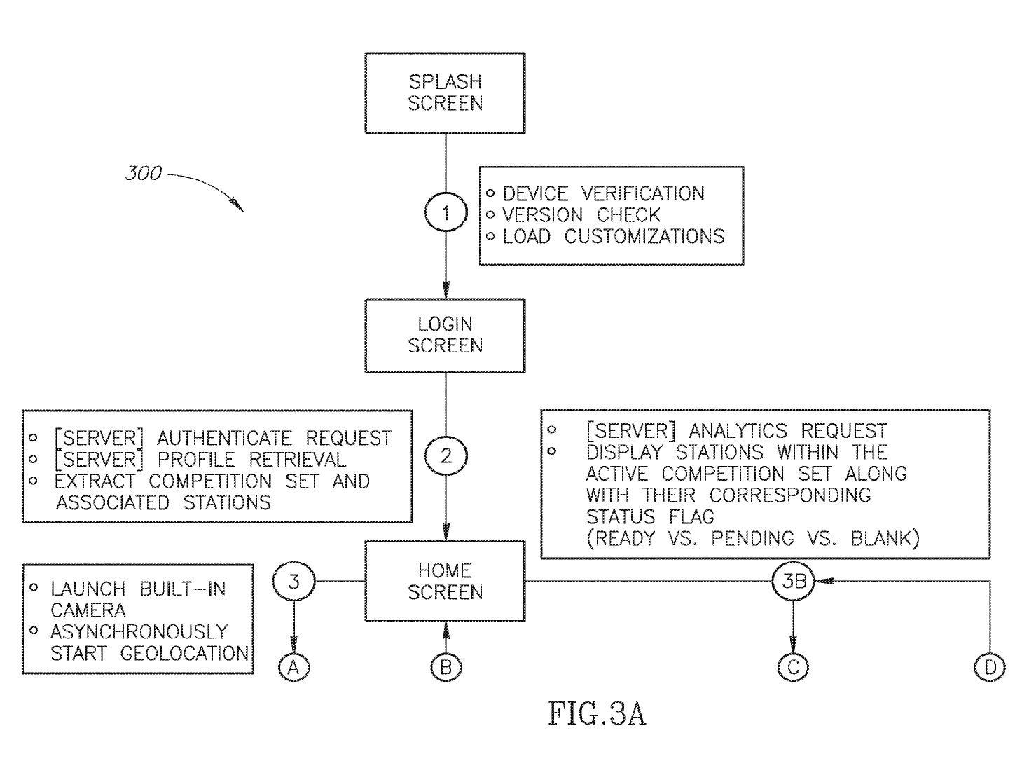

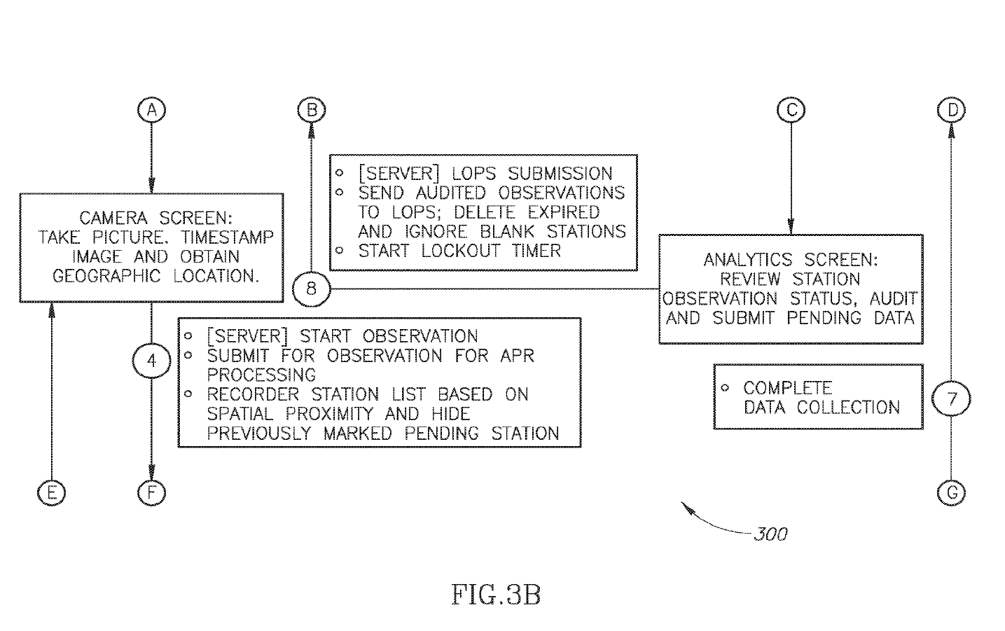

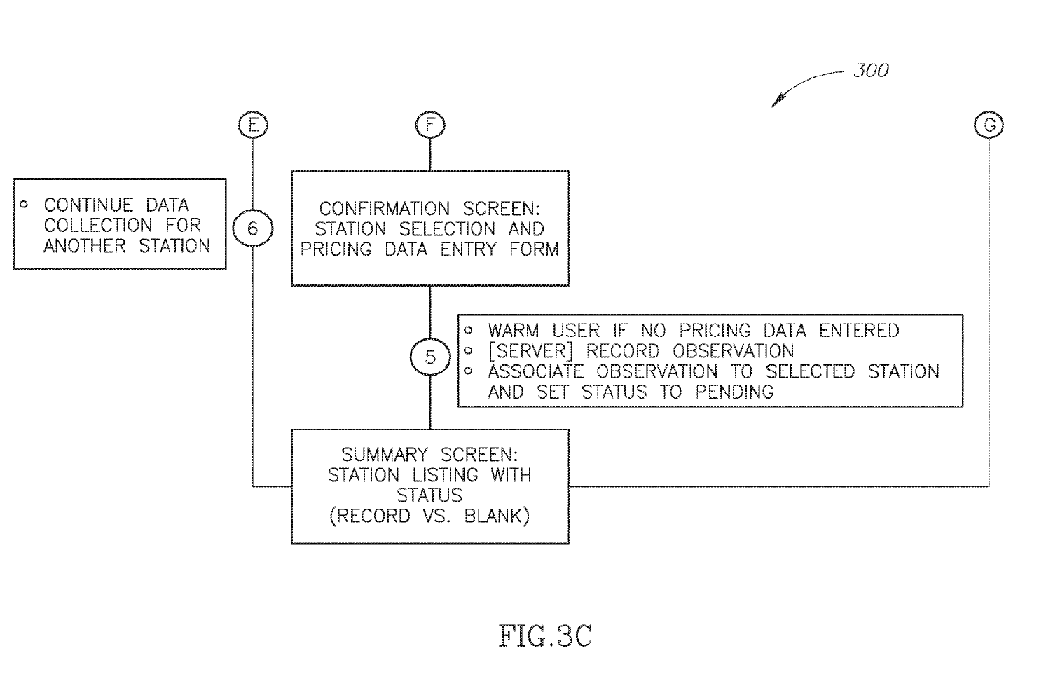

Generally referring to FIGS. 2 and 3, an embodiment includes retail-product (e.g., petrol/gasoline) price-data capture, robust infrastructure that provides quick and ready access to information and a flexible interface that supports a broad range of reporting and analysis. An embodiment allows field managers and retail-outlet/station operators to price sites and competitive groups directly from their mobile devices by entering, or otherwise recording, and reviewing key pricing decision criteria on a site-by-site basis.

An embodiment allows pricing teams to control the timing and frequency of price change requests and observations, while providing validation of observations based on rules specified by the petrol company, for example. At the same time, the system provides reports of all activity and an audit trail that allows the petrol company to verify current and historical price observations. In an embodiment, a process leverages the geo-locator (via, e.g., GPS, AGPS, Network) and camera functionality of a mobile networked device, such as a smartphone, to provide an auditable trail of captured data on which pricing analytics are based.

An embodiment involves gathering pricing data, then encoding the data to a particular protocol so that it can be fed into a client's pricing system. The client, in turn, takes the data, applies business rule(s) to the data, to effectuate automated changes to the client's retail fuel prices. Consequently, the client is able to dynamically and automatically update the retail price of its product based on rapidly gathered market conditions; the client is able update such prices based not only on prices currently charged by the client and/or its competitors, but also based on the geographic region in which such prices are currently charged.

An embodiment streamlines data collection and pricing system analytics. Powerful reports assist with in-depth analysis and quick action while convenient and verifiable data collection leads to fewer inaccurate price observations making it into the pricing system. A unique two-part solution allows the petrol company to implement its pricing strategy precisely, reducing the time taken to respond to changes in competitor price or other market conditions, and optimizes volume and margin.

The protocol between the mobile device and a server to which captured data is transmitted is compressed and encrypted to reduce bandwidth usage and prevent man-in-the-middle data interception. The components of such a server have a multi stage approach:

First a remote call may be made to a back-office system where the user's session is validated.

Second, the data from the mobile device is processed, and inserted into a database schema (aka tables).

Third, the data is cleansed, cross-referenced with an automatic price recognition (APR) result and then a confidence score is calculated.

Finally, the cleansed data is then pushed to a client's Fuel Pricing System (FPS) for near-real-time modifications to their retail pricing data along with the confidence score report also referred to as a Price Submission Report.

In an embodiment, for purposes of mobile retail-product price capture/recordation, users can access and download a mobile application via a URL, for example.

Once the user has downloaded and installed the application, an application ICON can appear in the user's mobile device application tray entitled “Petrol Analytics”. Clicking on this icon launches the application. As illustrated in the process 300 shown in FIG. 3, the user can be shown a splash screen while the application is loading a login screen.

The competitor sets including the gas stations or other product sources that are available for a particular user to collect pricing data from may be bound to or otherwise restricted by the user's email address or other personal data, such as the user's place of residence.

Upon login, the user may be asked for a login passcode associated with the email account of the user. The system may verify authentication and retrieve the user profile. Subsequently, the user may be presented with a user interface (not shown) that allows the user to select the industry/product type (e,g., gas stations, grocery retailers, automobile dealerships, etc.) for which the user will be collecting pricing information. In varying embodiments, the product type can be manually selected by the user or can be automatically determined/suggested based on the location of the phone. In this latter case, for example, if the device 210, 280 determines through geo-location capability that the device is positioned proximal to a car dealership, an embodiment may auto-suggest that price information be collected from such dealership.

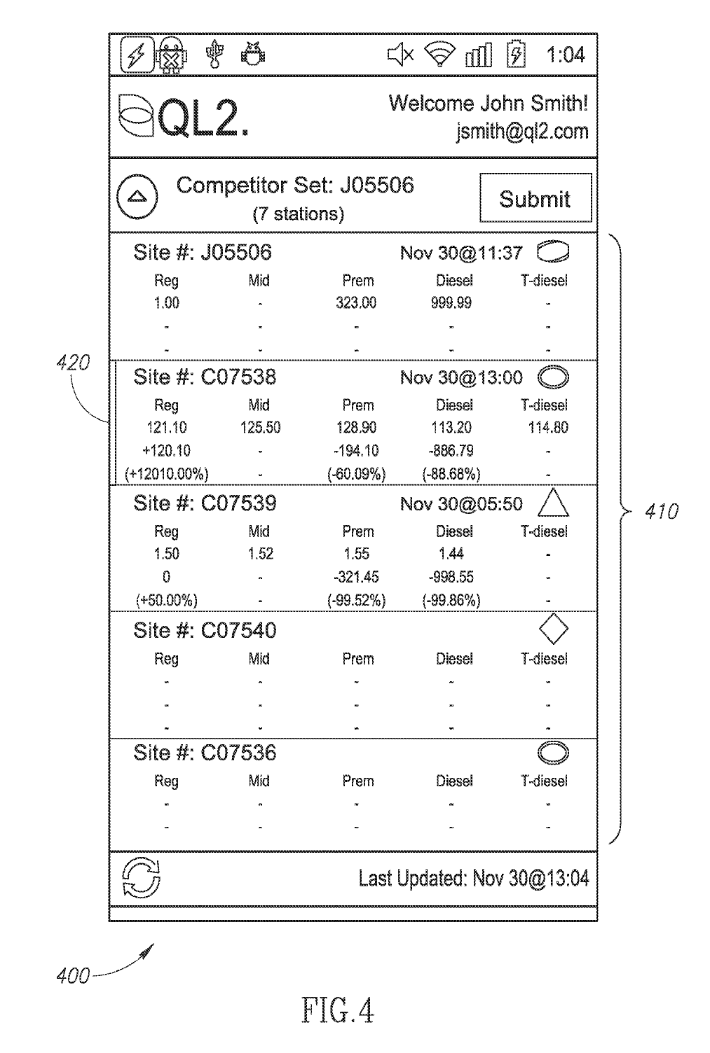

Upon login, and referring to FIG. 4, the user may be navigated to a landing page having a user interface 400 on which their competitor set 410 (i.e., a list of product-distribution sources or retailers from which the user is authorized to collect product-pricing data) may be displayed. In response to a user command, and as shown in FIG. 4, the set 410 may expand to show the name and other identifying indicia of each distribution source of the set, current price observations for each source, and any change over the most recent submission made by the user and/or other individual (if the prices associated with the source have been observed).

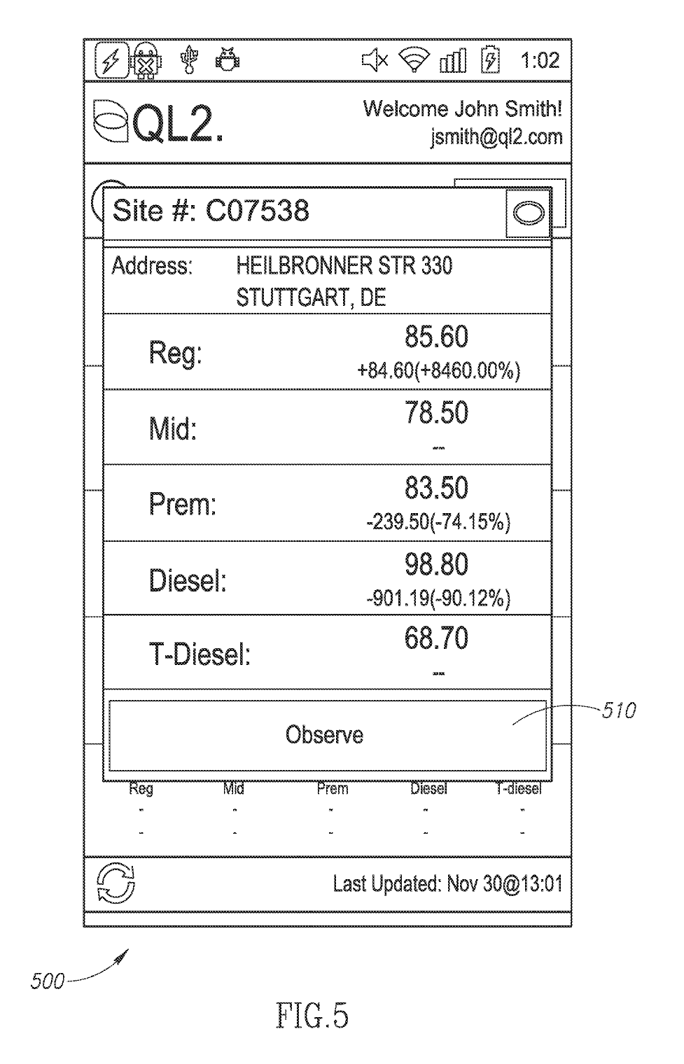

As illustrated in FIG. 5, selecting a particular source of the set 410 using the interface 400 provides an interface 500 that includes additional and/or specific detail regarding observations made concerning the selected source.

Referring again to FIG. 4, interface 400 may include a colored marker 420 (emphasized in FIG. 4 by a dashed box) or other indicia that provides information on the status of the price observations associated with a particular distribution source of the set 410.

In an embodiment, respective colored markers 420 may indicate the following respective statuses:
a. White—neutral state with no pending observations.
b. Yellow—observation has been recorded but has not undergone APR.
c. Green—observation has undergone APR and initial value and APR-audited values match.
d. Orange—observation has undergone APR and initial value and APR-audited values deviate.
e. Red—observation has been recorded but elapsed time has exceeded threshold and may be now marked as stale or expired.

One or more embodiments may employ manual data entry and confirmation, optical character recognition (OCR) techniques (performed by device 210, 280 and/or server 230) via mobile-device camera functionality or a combination of both for purposes of price-data collection and transmission.

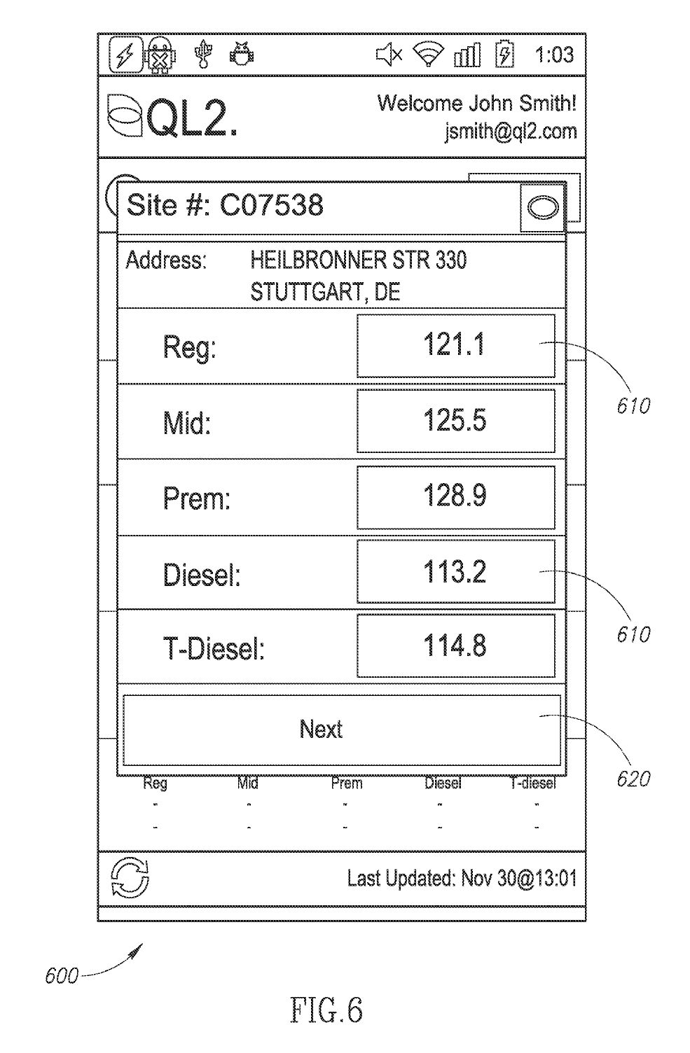

In order to start an observation, the user may select a particular source of the set 410 using the interface 400 to open up interface 500. Subsequently, the user may click on an “Observe” button 510, which may provoke the display of a data-entry interface 600, as is illustrated in FIG. 6. In an embodiment, and to avoid erroneous entry of price information, if a user is more than a predetermined distance (e.g., 250 m) away from the selected station/source, interface 500 may warn the user that the selected station may not be within range. Data-entry fields 610 in the interface 600 enable the user to manually enter advertised prices for products offered by the selected product source and observed by the user.

If the user does not enter prices and, for whatever reason, APR would fail, the user may not see any prices in any of the interfaces of the application and may need to go back to the station to re-observe the prices.

In order to transition from manual-observation mode (having manually entered prices or skipping such) to camera-observation mode, the user may select a button, such as the “Next” button 620 illustrated in FIG. 6. Selection of camera-observation mode may invoke a camera mode associated with the device 210, 280 and/or an application, enabling the user to photograph (i.e., capture an image of) prices displayed by the selected station/source, such as, for example, a price totem located at a gas station. This photograph may then be used by the APR process to determine and employ the respective product prices depicted therein. In an embodiment, any branding associated with the product source that may be included in the photograph may also be discerned, using the APR/OCR techniques, for purposes of automatically associating such source with the collected price data.

More particularly, the user may select an “OK” or other appropriate button from interface 600 after the photograph is taken, reviewed and determined by the user to be suitable for transmitting to server 230. This sends the observation to the database and initiates the APR process. The user can retake the picture as many times as is needed to get an acceptable picture.

As is illustrated in FIG. 3, the user can repeat steps 2 through 5 until observations for all stations/sources of the set 410 have been similarly completed. Prior to such pricing collection being completed, the user may have the opportunity to review and submit or override the pricing.

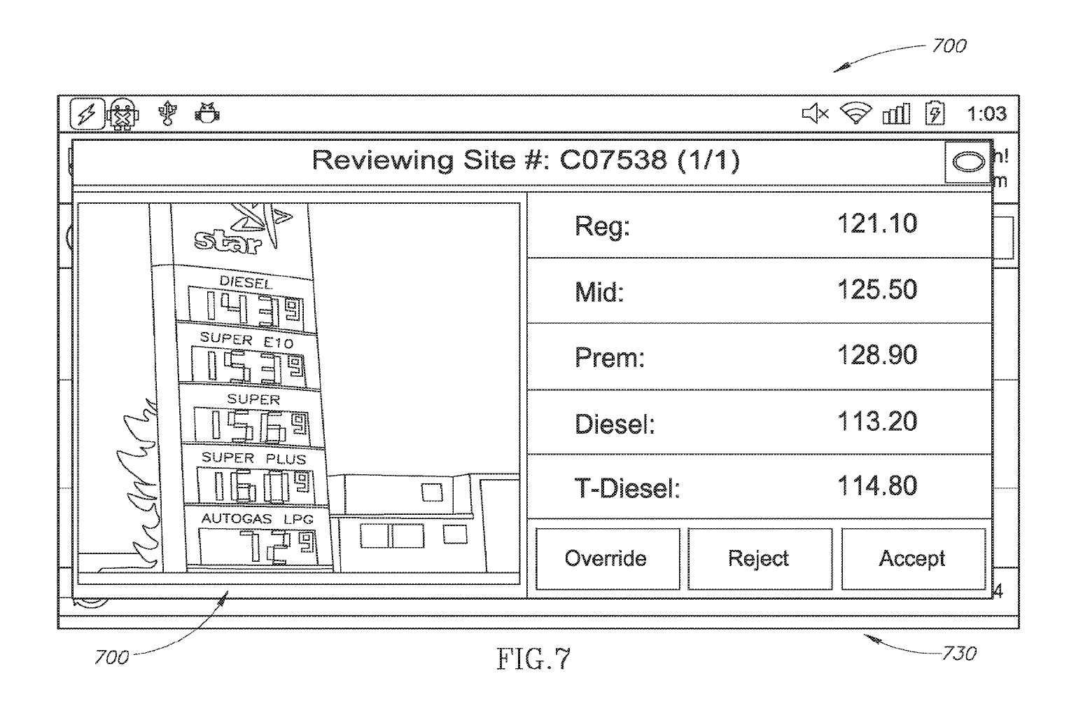

Referring to FIG. 7, for each source of the set 410, the user may invoke an interface 700 that includes the photograph 710 and pricing data 720, which device 210, 280 may have derived from the photograph using OCR techniques. Using buttons 730 of interface 700, the user can override, reject or accept photograph 710 and/or pricing data 720 as captured/determined by device 210, 280.

In an embodiment, once a user submits pricing data from the device 210, 280 to server 230, the server may place a temporary moratorium (e.g., 30 minutes) on further pricing data submission by that user.

While a preferred embodiment of the invention has been illustrated and described, as noted above, many changes can be made without departing from the spirit and scope of the invention. For example, in an embodiment, users can access an SSO Web application to enter pricing information in a manner similar to that described above herein via personal computer, for example. Instead, the invention should be determined entirely by reference to the claims that follow.

1. A computer-readable medium on which are stored computer-executable instructions that, when executed in at least one electronic system coupled to a display device and a network, enable the at least one system to perform a method comprising at least the steps of:
determining the geo-location of the system;
determining at least one on-sale retail product associated with the determined geo-location of the system;
recording a data set indicating a current price of the determined on-sale retail product; and
electronically transferring the data set and an indication of the determined geo-location over the network to a processing device.

2. The medium of claim 1, wherein the method further comprises the step of generating at least one graphical user interface to the display device, the at least one user interface being configured to present to a user of the system a listing of a plurality of retail product types, wherein determining at least one on-sale retail product comprises receiving from the user of the system a selection from the listing.

3. The medium of claim 1, wherein the method further comprises the step of electronically transferring an identifier of the determined on-sale retail product to the processing device.

4. The medium of claim 1, wherein the method further comprises the step of generating at least one graphical user interface to the display device, the at least one user interface being configured to present to a user of the n indication of accuracy of the recorded data set.

5. The medium of claim 1, wherein recording a data set comprises the step of capturing with the system photographic image of at least one displayed current price of the determined on-sale retail product.

6. The medium of claim 5, wherein the method further comprises the step of performing optical character recognition on the captured photographic image.

7. A computer-readable medium on which are stored computer-executable instructions that, when executed in at least one electronic system coupled to a network, enable the at least one system to perform a method comprising at least the steps of:
receiving over the network a data set and an indication of a geo-location, the data set indicating a current price of at least one on-sale retail product, the geo-location being associated with a distribution source of the at leas one on-sale retail product;
based on the received data set and geo-location, determining an update in price at which the on-sale retail product should be offered for sale; and
electronically communicating the updated price over the network to at least one retail location at which the on-sale retail product is sold.

8. A computer-readable medium on which are stored computer-executable instructions that, when executed in at least one electronic system coupled to a network, enable the at least one system to perform a method comprising at least the steps of:
receiving over the network a data set and an indication of a geo-location, the data set indicating a current price of at least one on-sale retail product, the geo-location being associated with a first distribution source of the at least one on-sale retail product;
based on the received data set and geo-location, determining an update in price at which the on-sale retail product should be offered for sale; and
electronically communicating the updated price over the network to a second distribution source of the at least one on-sale retail product.
